(19) United States
(12) Patent Application Publication
(10) Pub. No.: US 2025/0092233 A1
(43) Pub. Date: Mar. 20, 2025

(54) CHITOSAN-SUPPLEMENTED STARCH BIOAEROGELS AND METHODS OF MAKING AND USING THEREOF

(71) Applicant: NUtech Ventures, Lincoln, NE (US)

(72) Inventors: Ozan Ciftci, Lincoln, NE (US); Farhad Alavi, Lincoln, NE (US)

(21) Appl. No.: 18/889,297

(22) Filed: Sep. 18, 2024

Related U.S. Application Data
(60) Provisional application No. 63/583,495, filed on Sep. 18, 2023.

(51) Int. Cl. C08L 5/08; A23D 9/04; A23L 29/212; A23L 29/275; C08J 9/28; C08L 3/02; C08L 3/14

(52) U.S. Cl. CPC C08L 5/08; A23D 9/04; A23L 29/212; A23L 29/275; C08J 9/286; C08L 3/02; C08L 3/14; C08L 2201/06; C08L 2203/14

(57) ABSTRACT

The present disclosure provides bioaerogels comprising a quantity of chitosan combined with a quantity of starch. Chitosan supplemented bioaerogels are shown to have less shrinkage, less density, greater microporosity, and greater oil structuring capacity than bioaerogels that do not include chitosan. Such bioaerogels are especially suited for forming oleogels for food formulations.

### GOVERNMENT LICENSE RIGHTS

This invention was made with government support under the Novel Foods and Innovative Manufacturing Technologies program (grant no. 2020-67017-31276) from the USDA National Institute of Food and Agriculture. The government has certain rights in the invention

### BACKGROUND

It is widely acknowledged that the consumption of polyunsaturated fats over saturated fats is favorable to promote cardiovascular healthiness. World Health Organization (WHO) guidelines on dietary saturated fatty acids (SFA) and trans fatty acids (TFA) advise limiting the consumption of total SFA to less than 10% of total energy intake of our diet and replacing them with monounsaturated and polyunsaturated fats because high consumption of SFA is associated with cardiovascular diseases and related mortality. Solid fats such as shortenings, butter, partially hydrogenated vegetable oils, and the saturated fraction of palm oil are the main sources of saturated fatty acids in the human diet. However, removing the saturated fats from the food formulation is not a simple task because the presence of saturated solid fats in food products has significant impact on texture, colloidal stability, rheology, and organoleptic characteristics of many food formulations. On the other hand, with the ban on partially hydrogenated fats in the United States and the recent concerns about the negative health effects of palm oil and environmental damage done by palm plantations, one thing that is needed in the art are alternate approaches to formulate solid fats with a healthier nutritive profile without depreciation of their technological functionality.

The oleogelation technique, through which liquid oil is entrapped into a three-dimensional network of self-assembled molecules or polymers (i.e., structuring agent), has been suggested as a possible process to transform unsaturated liquid oils into a solidified fat. The main factor in the field of edible oleogels is finding gelator agents that function at low concentrations, are inexpensive and readily available, and, most importantly, meet regulatory prerequisites for use in edible products. Oil structuring agents can be classified as direct oleogelation and indirect oleogelation. In direct oleogelation, low molecular mass gelators or high molecular weight polymeric gelators are added to liquid oil, then the mixture is heated above the melting temperature of the gelator, and followed by controlled cooling that allows the oleogelator to self-assemble into supramolecular networks that entrap oil. Many low molecular mass gelators (LMOGs) that were studied as oleogelator include phytosterols, hydroxylated fatty acids, monoacylglycerols, ceramides, and plant waxes, while among high molecular weight polymer oleogelators, only ethylcellulose has been reported for direct oil structuring. Most LMOGs have some limitations, for instance, some LMOGs-based oleogels have a waxy texture and low-temperature stability and melt down at elevated temperatures. Furthermore, the heating phase required for the oil structuring limits the application of direct oleogelation methods for heat-sensitive oils and formulations because heating may trigger oil oxidation.

Indirect oleogelation can be achieved by first forming a hydrogel structure, in which the continuous phase is water, and then replacing this aqueous phase with a liquid oil phase. This method includes i) the emulsion-template method in which the water-in-oil emulsion formation is followed by water removal, resulting in structured oil consisting of closely packed oil droplets; ii) solvent exchange in which the internal aqueous phase of hydrogel is replaced with an intermediate solvent followed by liquid oil; iii) the physical immobilization of liquid oil in porous structures such as aerogels or cryogels.

Aerogels are porous, low dense materials that are created through evaporating the solvent from a hydrogel through supercritical-CO₂ (SC-CO₂) drying technology or freeze-drying (later one usually called cryogel). In the last two decades, many aerogels were developed from synthetic polymers such as polystyrenes or inorganic materials such as metal oxides and silica. Nevertheless, in the food and biopharmaceutical sectors, bio-based aerogels obtained from edible biopolymers show superior potential in terms of safety and biocompatibility. Due to their highly porous structure, bio-based aerogels are considered excellent templates through which a liquid oil can be immobilized to form self-standing semi-solid structures. Recently, Plazzotta, Calligaris, and Manzocco (2020) and Plazzotta at at. (2021) employed whey protein isolate (WPI) aerogels to fabricate oleogels. According to the results from previous studies, the oleogelation performance of the aerogels was mainly determined by the density and macroporosity of aerogel.

Among biopolymers, starch has attracted particular attention for the formation of bio-based aerogels because it is inexpensive, nontoxic, and abundant. Starch produces strong hydrogels after heat-induced gelatinization and retrogradation without the need for any chemical cross-linker. Starch aerogels fabricated through SC-CO₂ drying showed high porosity and surface area. Previous studies showed that the hydrogel formation conditions such as the source of starch, concentration, amylose/amylopectin ratio, and degree of gelatinization determine the surface area, density, and porosity of the resulting aerogels. Some recent studies showed that higher amylose content usually leads to a higher specific surface area. Furthermore, it has been shown that a mixture of starch with biopolymers such as agar or microcrystalline cellulose can be another way to modulate the properties of the final aerogels. However, the art is still in need of information on the effect of starch type, amylose/amylopectin ratio, and aerogel microstructure on the oleogelation capacity of the aerogels. What is still further needed are bioaerogels for food structuring.

### SUMMARY OF THE DISCLOSURE

The present disclosure solves the problems inherent in the prior art and provides chitosan-supplemented starch bioaerogels. In general, this disclosure used chitosan to develop composite starch bioaerogels. Chitosan is an abundant biopolymer derived from seafood waste through the deacetylation of chitin. Chitosan shows attractive properties, particularly its high biocompatibility, and easy chemical processability. Chitosan contains plentiful of amine groups (—NH₂) that can interact with hydroxyl groups (—OH) of amylose/amylopectin chains and modulate the properties of the starch hydrogels and subsequent aerogels, which leads to better oil structuring functionalities. The present disclosure provides the first evidence regarding how the addition of chitosan influences the properties of starch-based aerogels and their functionality. In this context, this disclosure details the effect of amylose content and chitosan incorporation on the physicochemical properties and functionality of starch-based aerogels intended for food-grade oleogel production.

Oleogelation is a novel fat structuring method for converting liquid oils to solidified oil to reduce saturated trans-fatty acids and fatty acids in food formulation. In the current disclosure, the impact of starch type and chitosan addition on the oleogelation capacity of aerogels obtained from supercritical CO₂ drying technology was investigated. Additionally, the term “oleogelation” as used herein, is used as an equivalent to “oil structuring” and not in reference to conventional oleogels. The starch hydrogel precursors were prepared from dent starch (27% amylose content), 55% amylose, and 72% amylose starch in the presence of 0, 0.50, and 0.75 wt. %. The starch type showed a significant effect on the characteristics of resulting aerogels, where aerogels with higher content of amylose showed significantly lower shrinkage and density and higher specific surface area and macroporosity. Furthermore, chitosan addition substantially decreased the shrinkage of the aerogels, particularly those prepared with the dent starch, resulting in aerogels of lower density and higher surface area and macroporous volume. These aerogels were then powdered and employed as oil-absorbing porous materials for structuring soybean oil. Results showed that the aerogels from 55% amylase and 72% amylose starch had better oil structuring capacity compared to those from the dent starch. Furthermore, the starch aerogels supplemented with chitosan showed superior oil structuring ability than the neat starch aerogel counterparts, where solid-like texture oleogels with strong elastic modules were developed when the composite starch/chitosan aerogels were used as a template. This disclosure shows that the starch type and the presence of chitosan has deep impacts on the macroporosity of the starch aerogels and their oil structuring performance.

In one aspect of the present disclosure, A starch bioaerogel composition comprising a quantity of starch; and a quantity of solubilized chitosan is provided. In some forms, the quantity of chitosan ranges from 0.1% to 1% by weight. In some forms, the quantity of chitosan is 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1%. In some forms, the quantity of chitosan is between 0.25% to 0.75% by weight. In some forms, the quantity of chitosan is 0.25, 0.3, 0.35, 0.4, 0.45, 0.5, 0.55, 0.6, 0.65, 0.7, or 0.75% by weight. In some forms, the starch contains a quantity of amylose. In some forms, the quantity of amylose ranges from 27-80%. In some forms, the quantity of amylose is 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80%. In some forms, the quantity of amylose is selected from the group consisting of 27%, 55%, and 72%. In some forms, the quantity of starch is between 0.1% and 20%. In some forms, the quantity of starch is 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20. In some forms, the bioaerogel is formed by evaporating alcohol from an alcogel that contains a quantity of starch and a quantity of chitosan.

In another aspect of the present disclosure, the starch bioaerogel is formed by adding a quantity of chitosan to a quantity of starch during the formation of an aerogel. In some forms the chitosan is solubilized prior to being combined with the starch. In some forms, the quantity of chitosan ranges from 0.1% to 1% by weight. In some forms, the quantity of chitosan is 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1%. In some forms, the quantity of chitosan is between 0.25% to 0.75% by weight. In some forms, the quantity of chitosan is 0.25, 0.3, 0.35, 0.4, 0.45, 0.5, 0.55, 0.6, 0.65, 0.7, or 0.75% by weight. In some forms, the starch contains a quantity of amylose. In some forms, the quantity of amylose ranges from 27-80%. In some forms, the quantity of amylose is 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80%. In some forms, the quantity of amylose is selected from the group consisting of 27%, 55%, and 72%. In some forms, the quantity of starch is between 0.1% and 20%. In some forms, the quantity of starch is 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20. In some forms, the method further comprises at least on the steps of solubilizing the quantity of chitosan in an aqueous solution to form a chitosan solution; mixing the chitosan solution with the quantity of starch to form a hydrogel; gelatinizing the starch in the hydrogel; allowing the starch in the hydrogel to retrograde; transforming the hydrogel to an alcogel by performing a solvent exchange using alcohol; evaporating the alcohol to form the bioaerogel, and any combination thereof.

In some forms, the hydrogel formed above comprises 10% starch (w/w).

In another aspect of the present disclosure, an oleogel comprising a bioaerogel and oil is provided. In some forms, the bioaerogel comprises the components and is made using the methods described above.

In another aspect of the present disclosure, a method of improving at least one characteristic of a bioaerogel is provided. In general, the method includes the step of making a bioaerogel as described above. In some form, the improvement of the at least one characteristic is in comparison to a bioaerogel that does not comprise the bioaerogel comprising the bioaerogel comprising the components or made as described above. In some forms, the improved characteristic is selected from the group consisting of less shrinkage, less density, greater microporosity, greater oil structuring capacity, and any combination thereof.

In another aspect of the present disclosure, a novel green cold gelation approach was developed to fabricate superlight macroporous aerogels from egg white protein (EWP). The cold-set hydrogels were prepared through preheating of EWP solution at high alkaline pH and then the gelation was induced by a food-grade crosslinker, glucose-d-lactone (GDL). The cold-set hydrogels prepared by this method showed mechanical strength comparable to the heat-set hydrogels obtained by direct heating of EWP solution, but with much less biopolymer (protein) content. The hydrogels were then used to produce porous EWP aerogels by supercritical carbon dioxide (SC-CO₂) drying. While aerogels obtained from the heat-set hydrogels showed a compact structure with high density and low macroporosity, the aerogels obtained from the cold-set hydrogels had 3-5 times the lower density and significantly higher macroporous volume, due to the lower biopolymer concentration and less shrinkage of their precursor hydrogels. These aerogel scaffolds were then employed as templates for structuring a liquid soybean oil. Compared to the aerogels obtained from the heat-set hydrogels, the aerogels from the cold-set hydrogels showed excellent oil structuring capacity, where solid-like, plastic oleogels with an elastic module of more than 2.0×10⁵ Pa were developed. This work suggests that the gelation method had profound effects on the density and porosity of the EWP aerogels and the oil structuring capacity of the aerogels.

In another aspect of the present disclosure, the starch/chitosan-based bioaerogels are incorporated into a food product. In some forms, the starch/chitosan-based bioaerogels replace saturated fat and/or another type of aerogel or hydrogel in a food product during the formulation thereof. In some forms, the starch/chitosan-based bioaerogels of the present disclosure are utilized for their high oil structuring characteristics in food formulations.

In another aspect, a food product incorporating a starch/chitosan-based bioaerogel in accordance with the present disclosure is provided.

In another aspect, a method of substituting a saturated fat, another type of aerogel, and/or another type of hydrogel for a starch/chitosan-based bioaerogel of the present disclosure is provided. In some forms, at least 20, 30, 40, 50, 60, 70, 80, 90, 95, 96, 97, 98, 99, or even 100% of the saturated fat, other type of aerogel, and/or other type of hydrogel is substituted with a starch/chitosan-based bioaerogel of the present disclosure.

In another aspect, a method of providing healthier nutrition choices is provided. In some forms, the healthier nutrition choices include at least one food product that is formulated with a starch/chitosan-based bioaerogel in place of at least some saturated fat, another type of aerogel, and/or another type of hydrogel is provided.

In another aspect, a method of increasing the biocompatibility of a food product is provided. In some forms, the method substitutes a starch/chitosan-based bioaerogel of the present disclosure for at least some saturated fat, another type of aerogel, and/or another type of hydrogel in the food product. In some forms, this same method decreases the toxicity of the food product.

In another aspect, aerogels with higher oil structuring capacity are provided by the starch/chitosan-based bioaerogels of the present disclosure. In some forms, the microporous volume is increased in comparison to an aerogel that does not include chitosan supplementation or addition but is similar or identical in all other respects in formulation and production. In some forms, the increase in microporous volume is at least 5, 10, 15, 20, 25, 30, 35, 40, 45, 50, 55, 60, 61, 62, 63% or more in comparison to an aerogel that does not include the chitosan addition or supplementation but is similar or identical in all other respects in formulation and production.

In another aspect, aerogels with increased strength as evidenced by an increase in the storage modulus of the hydrogel precursors are provided by the starch/chitosan-based bioaerogels of the present disclosure. In some forms, the storage modulus is increased in comparison to an aerogel that does not include chitosan supplementation or addition but is similar or identical in all other respects in formulation and production. In some forms, the increase in storage modulus is at least 5, 10, 15, 20, 25, 30, 35, 40, 45, 50, 55, 60, 61, 62, 63% or more in comparison to an aerogel that does not include the chitosan addition or supplementation but is similar or identical in all other respects in formulation and production.

### BRIEF DESCRIPTION OF THE DRAWING FIGURES

FIG. 1 is a panel of graphs with panel 1a illustrating the Zeta-potential of the starch suspension (0.1 wt. %) with different amylose contents mixed with 0, 0.0050, and 0.0075 wt. % chitosan. Panel 1b illustrates the storage modulus (G′) and loss modulus (G″) of hydrogels prepared from dent starch (27% amylose) mixed with 0, 0.50, and 0.75 wt. % chitosan; panel 1c illustrates the storage modulus (G′) and loss modulus (G″) of hydrogels prepared from 55% amylose starch mixed with 0, 0.50, and 0.75 wt. % chitosan; and panel 1d illustrates the storage modulus (G′) and loss modulus (G″) of hydrogels prepared from 72% amylose starch mixed with 0, 0.50, and 0.75 wt. % chitosan.

FIG. 2 is a panel of a photograph and graphs with panel 2a providing a photograph illustrating the visual appearance of the aerogels (1: dent starch with 0 wt. % chitosan; 2: dent starch with 0.50 wt. % chitosan; 3: dent starch with 0.75 wt. % chitosan; 4: 55% amylose starch with 0 wt. % chitosan; 5: 55% amylose starch with 0.50 wt. % chitosan; 6: 55% amylose starch with 0.75 wt. % chitosan; 7: 72% amylose starch with 0 wt. % chitosan; 8: 72% amylose starch with 0.50 wt. % chitosan; 9: 72% amylose starch with 0.75 wt. % chitosan); panel 2b is a graph illustrating the XRD patterns of aerogels prepared from dent starch mixed with 0, 0.50, and 0.75 wt. % chitosan; panel 1c is a graph illustrating the XRD patterns of aerogels prepared from 55% amylose starch mixed with 0, 0.50, and 0.75 wt. % chitosan; and panel 1d is a graph illustrating the XRD patterns of aerogels prepared from 72% amylose starch mixed with 0, 0.50, and 0.75 wt. % chitosan.

FIG. 3 is a panel of SEM pictures of aerogels prepared from dent starch, 55% amylose starch, and 72% amylose starch mixed with 0, 0.50, and 0.75 wt. % chitosan.

FIG. 4 is a panel of 3 photographs that provide visual images of the oleogels made by aerogels prepared from dent starch, 55% amylose starch, and 72% amylose starch mixed with 0 and 0.50 wt. % chitosan at aerogel-to-oil ratios of 1:6 (panel a), 1:8 (panel b), and 1:10 (panel c). For each panel, the sample descriptions are as follows: sample 1: oleogel prepared from dent starch with 0 wt. % chitosan; sample 2: oleogel prepared from dent starch with 0.50 wt. % chitosan; sample 3: oleogel prepared from 55% amylose starch with 0 wt. % chitosan; sample 4: oleogel prepared from 55% amylose starch with 0.50 wt. % chitosan; sample 5: oleogel prepared from 72% amylose starch with 0 wt. % chitosan; sample 6: oleogel prepared from 72% amylose starch with 0.50 wt. % chitosan.

FIG. 5 is a panel of graphs illustrating viscoelastic curves (G′ and G″ vs. frequency) of the oleogels made by aerogels prepared from dent starch (panels a, d, and g), 55% amylose starch (panels b, e, and h), and 72% amylose (panels c, f, and i) starch mixed with 0 (dark squares) and 0.50 wt. % (blue diamonds) chitosan at aerogel-to-oil ratios of 1:6 (a, b, and c), 1:8 (d, e, and f), and 1:10 (g, h, and i). Filled shapes show storage modulus (G′) and empty shapes represents loss modulus (G″).

FIG. 6 is a panel of graphs illustrating flow curves (viscosity vs. shear rate) of oleogels made by aerogels prepared from dent starch, 55% amylose starch, and 72% amylose starch mixed with 0 and 0.50 wt. % chitosan at aerogel-to-oil ratios of 1:6 (panel a), 1:8 (panel b), and 1:10 (panel c).

FIG. 7a is a graph illustrating temperature sweep curves of the oleogels produced from aerogels prepared from dent starch, 55% amylose starch, and 72% amylose starch mixed with 0 and 0.50 wt. % chitosan at aerogel-to-oil ratios of 1:8; and

FIG. 7b is a graph illustrating DSC thermograms of the oleogels produced from aerogels prepared from dent starch, 55% amylose starch, and 72% amylose starch mixed with 0 and 0.50 wt. % chitosan at aerogel-to-oil ratios of 1:6.

### MATERIALS AND METHODS

### 1.1. Materials

Corn starch with varying amylose contents (27% (dent), 55%, and 72% amylose) was provided by Ingredion (IL, United States). Pure soybean oil was obtained from a local store (Kirkland Signature brand, Cargill, United States). Medium molecular weight chitosan (75-85% deacetylated, CAS Number: 9012-76-4) was purchased from Sigma-Aldrich Company (United States). Matheson Tri-Gas, Inc. (PA, United States) provided CO2 (purity>99.99%). Decon Laboratories (PA, United States) provided ethanol (200 proof, anhydrous).

### 1.2. Hydrogel and Aerogel Formation

To create hydrogels, chitosan was solubilized in a 1.0% acetic acid aqueous solution to obtain a biopolymer concentration of 0.5 and 0.75 wt. % and then the solutions were mixed for 24 hours. Then, starch was added to the chitosan solutions to obtain 10% (w/w) starch content in the final hydrogel. The pH of the mixtures was adjusted to 5.8 (equal to the pH of 10% (w/w) starch solution), and the mixtures were then transferred into a thermal reactor (4520 Bench Top Reactor, Parr Instrument Company, IL, United States) and mixed up at a mixing rate of 600 rpm for 5 min at 25° C. Starch gelatinization was performed by heating the starch suspensions at 120° C. for 20 min at 600 rpm, and then the suspensions were cooled down to 85° C. at the same mixing rate. Next, the warm starch suspensions were dispensed into 50 mL plastic cylindrical tubes with 26 mm inside diameter and stored at 4° C. for 48 hours for starch retrogradation of the 55% and 72% amylose starch samples and 7 days for the dent starch samples. The formed hydrogels were then taken from the containers, cut into cylinders of 15 mm in length. Then, transformation of the hydrogel monoliths to alcogel was done by solvent exchange stage according to the following procedure: soaking the hydrogels for 6 hours in 30% ethanol, then for 12 h in 70% ethanol, and then three times soaking in the 100% ethanol, each time for 24 hours. Ultimately, aerogels were created by evaporating the ethanol in the alcogels by SC-CO₂ drying in a lab-made SC-CO₂ drying apparatus at 100 bar for 4 hours in 40° C. and a CO₂ flow rate of 3 mL/min CO₂. Then, the system was depressurized at 4 bar/min and starch aerogels were stored in sealed boxes at 40° C. for subsequent analysis.

The following codes were applied for the aerogels in the study: dent-0% C, dent-0.50% C, and dent-0.75% C aerogels correspond to the parental hydrogels prepared from dent starch containing 0, 0.50, and 0.75% chitosan, respectively; the 55% Amyl-0% C, 55% Amyl-0.50% C, and 55% Amyl-0.75% C aerogels correspond to the parental hydrogels prepared from 55% amylose starch containing 0, 0.50, and 0.75% chitosan, respectively; and the 72% Amyl-0% C, 72% Amyl-0.50% C, and 72% Amyl-0.75% C aerogels correspond to the parental hydrogels prepared from 72% amylose starch containing 0, 0.50, and 0.75% chitosan, respectively.

### 1.3. Zeta-Potential

Zeta-potential of the starch/chitosan binary mixtures was measured by dynamic light scattering (DLS) technique by a Zetasizer Nano ZS instrument (Malvern Instruments Ltd., UK) at 25° C. The chitosan was added to distilled water to obtain a chitosan concentration of 0.005 and 0.0075 wt. %, and the solutions were stirred up for 24 hours for full hydration. Afterward, starch samples were added to the chitosan solutions to obtain 0.1 wt. % starch content in the final mixtures. The pH of the mixtures was adjusted to 5.8 and the solutions were stirred for 60 min before zeta-potential measurements. The zeta potential of the 0.1 wt. % starch solutions (0, 55, and 72% amylose) and the 0.05 wt. % chitosan solution were also measured.

### 1.4. Rheological Properties of Starch Hydrogels

Neat starch and starch/chitosan solutions were gelatinized as described above. After the retrogradation step, hydrogels were taken from the tubes, cut into monoliths of 5 mm length, and their rheological properties were measured by a Rheometer (MCR 301 Anton Paar Physica, Germany) using a 50 mm diameter parallel plate disc and 5000 μm gap at 25° C. A frequency sweep test is performed to obtain the viscoelastic moduli (storage (G′) and loss (G″) moduli) of the samples at the frequency range of 0.1-10 Hz and 0.25% strain. This strain was in the linear viscoelastic range of all the hydrogels according to our preliminary tests.

### 1.5. Aerogel Properties

### 1.5.1. Volumetric Shrinkage and Density

The change in original volume of samples after the solvent exchange step and after the SC-CO₂ drying step was determined by measurement of the dimensions of the samples with a caliper. The volumetric shrinkage of the samples was obtained using the following equation.

$$Δ V ( \% ) = ( \frac{{V}_{0} - {V}_{f}}{{V}_{0}} ) \times 100 \qquad ( Eq . l )$$

where the V_{f} represents the volume of the hydrogel and aerogel monoliths after the solvent exchange step or SC-CO₂ drying, and the Vo is the initial volume of the hydrogel monoliths.

The bulk density of the aerogel monoliths was calculated by measurement of the volume and weight of the aerogels. Volumetric shrinkage and density results were obtained from ten sample measurements.

### 1.5.2. Scanning Electron Microscopy (SEM)

An S4700 scanning electron microscope (Hitachi, Japan) was used for imaging the internal architecture of the aerogel monoliths (10 mA and 5 kV). Tiny pieces of aerogel monoliths were mounted on the stub using double-sided conductive carbon tapes and covered with chromium for conductivity prior SEM imaging.

### 1.5.3. BET Surface Area and BJH Mesopore Volume

An ASAP 2460 instrument (Micromeritics Instrument, GA, United States) was used to obtain Brunauer-Emmett-Teller (BET) specific surface area and Barrett-Joyner-Halenda (BJH) mesopore pore volume and pore size of the aerogel samples using nitrogen adsorption-desorption method. Before analysis, the aerogel samples were de-aired under vacuum for 12 hours at 115° C.

### 1.5.4. X-Ray Diffraction Analysis

Crystal structure of the neat starch and starch/chitosan aerogels was investigated using a high-resolution X-ray diffractometer equipped with a CuKα X-ray source (Rigaku SmartLab, working wavelength of 1.5406 Å). The aerogels were crushed into fine powders and analyzed at 8°-40° C.

### 1.6. Oleogel Formation

Oleogels were obtained by mixing oil with different ratios to the crushed aerogels. Aerogel monoliths were first crushed for 30 seconds by a 11 basic Analytical mill (IKA, Germany), and soybean oil was then mixed with the grounded aerogels at aerogel to oil mass ratio of 1:10, 1:8, 1:6. The samples were vortexed for 30 seconds and then homogenized by an Ultra-Turrax T25 disperser at 10,000 rpm for 1 min (IKA-Werke, Germany). The oleogel samples were kept for 24 hours in sealed containers at room temperature before further characterization. For each treatment, at least three oleogels were formed for analysis.

### 1.7. Oleogel Characterization

### 1.7.1. Rheological Characteristics

An MCR 301 Anton Paar Physica Rheometer (Anton Paar, Germany) equipped with 50 mm diameter parallel plate discs were used for rheological characterization of oleogels. The gap size was 1000 μm and the tests were replicated 3 times for each sample.

### 1.7.1.1. Viscosity

The viscosity of the oleogels was probed at the shear rate of 1 to 200 s⁻¹ at 25° C. and then the Power-law equation (Eq. 3) was employed for fitting the viscosity-shear rate curves using Microsoft Excel:

$$τ = K \cdot {( γ )}^{n} \qquad ( Eq . 3 )$$

where K shows the consistency index (mPa·sⁿ), γ is the shear rate, and n represents the flow behavior index.

### 1.7.1.2. Frequency Sweep Test

The storage (G′) and loss (G″) moduli of oleogels were studied by frequency sweep tests at the 0.1-10 Hz and 0.1% strain at 25° C. This strain was in the linear viscoelastic range of all the hydrogels according to our preliminary tests. The frequency dependence of G′ of the samples were determined by fitting frequency sweep data by the Power-law model:

$${G}^{′} = a {ω}^{n} \qquad ( Eq . 4 )$$

where G′ is storage modulus, “n” shows the frequency exponent, and “a” represents the Power-law constant.

### 1.7.1.3. Temperature Sweep Test

A temperature sweep test was performed to assess the heat-induced structural modification of the oleogel samples. The oleogel samples were analysed with a heating and cooling cycle [25→90 (held for 10 min)→25° C.] at a constant rate of 4° C./min for the heating cycle. The storage (G′) and loss (G″) modulus were determined continuously during the heating and cooling cycle treatment at a frequency of 1 Hz and a strain of 0.1%.

### 1.7.2 Melting Behavior

The melting behavior of the oleogels was studied using a differential scanning calorimeter (Netzsch DSC Phoenix 204 F1, Netzsch, Germany). Oleogel samples were weighed into a sealed aluminum pan and experiments were performed using a 10° C. min⁻¹ heating/cooling rate with a 20 ml min⁻¹ nitrogen flow rate. First, samples were cooled down to −100° C., and then temperature was increased from −100 to 100° C. at 10° C./min. Soybean oil was also analyzed as a reference.

### 1.8 Statistics

Results were described as mean±standard deviation. Duncan's test with a level of 0.05 (IBM SPSS, version 22) were employed for determination of the significant differences between the means.

### 2. RESULTS AND DISCUSSION

### 2.1. Zeta-Potential of Starch/Chitosan Binary Solutions

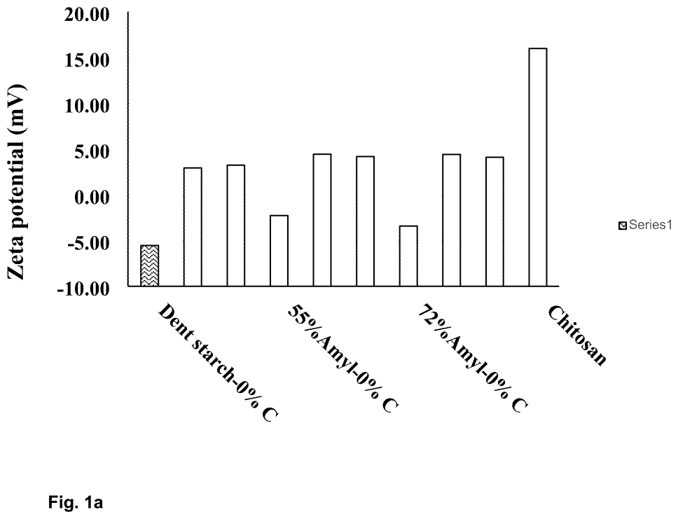

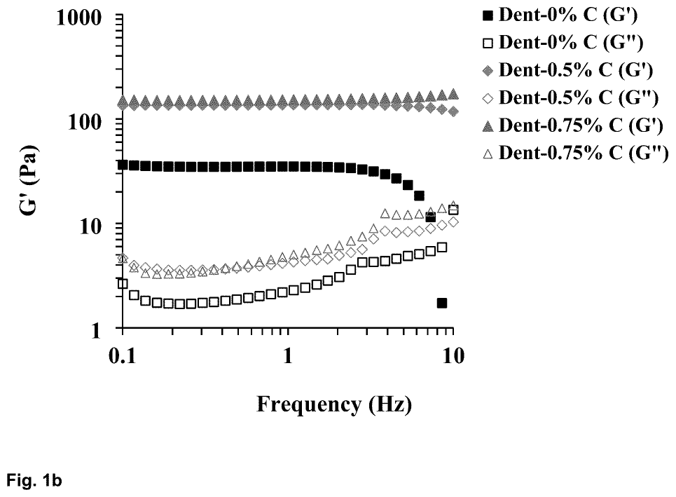

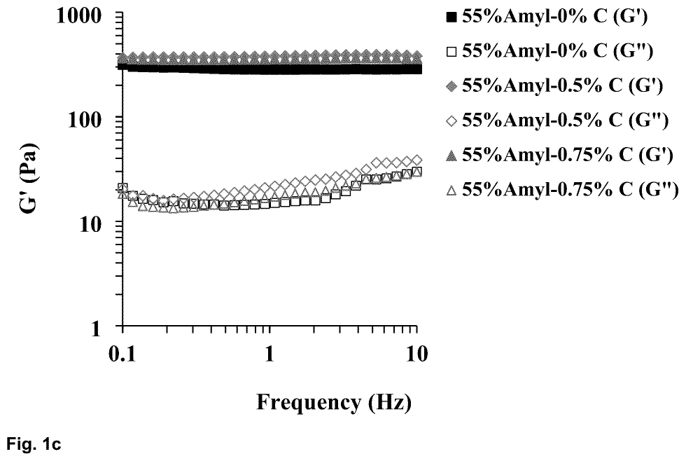

The complexation behavior of starch and chitosan was studied at pH 5.8 (the pH that hydrogel samples were formed). Regardless of their amylose content, all starch suspensions showed a slight net negative charge at pH 5.8 (−2.3 to −5.6 mV) (FIG. 1a). The slight negative charge of starch solutions might be related to the deprotonation of some-OH groups of glucose units in amylose and amylopectin chains, leaving a slight negative charge on starch molecules at pH 5.8. Chitosan solution showed a relatively high net positive charge at pH 5.8 (+15.0 mV). The pKa of the primary amine of chitosan is ˜6.5-6.8, depending on the degree of N-deacetylation. Thus, the amine groups contribute to the net positive charge of chitosan at pH 5.8, as —NH₂ groups of chitosan chains are protonated when solution pH is lower than pKa, leaving a positive charge on chitosan molecules. Compared to starch solutions, the starch/chitosan mixtures showed a shift from the initial negative charge to a slightly positive charge. Increasing the chitosan ratio from 0.005 wt. % to 0.0075 wt. % had no significant effect on the net charge of the binary systems. At pH 5.8, the overall charge of the starch molecules was negative, while chitosan molecules carried a positive charge, so the charge shifting confirmed that starch and chitosan interact electrostatically with positively charged chitosan to form intramolecular complexes.

### 2.2. Hydrogel Rheology

With neat starch hydrogels, gels with proper consistency and toughness for handling during the SC-CO₂ drying process were obtained by 55% amylose and 72% amylose starch samples (i.e., 55% Amyl-0% C and 72% Amyl-0% C samples). However, neat starch (27% amylose) hydrogel obtained from dent starch (dent-0% C) showed weak firmness and its handling was challenging. Viscoelastic moduli curves of starch hydrogels are shown in FIG. 1b-d. The storage modulus (G′) of the 55% Amyl-0% C and 72% Amyl-0% C hydrogels was significantly higher than that of dent-0% C, and the G′ of former samples remained almost constant at 0.1-10 Hz, while a considerable decrease in the elastic modulus (G′) of the 5-0%, 5-30%, and 8-0% hydrogels were observed in higher frequencies. The G′ of hydrogel samples at a frequency of 1 Hz (G′₁) are presented in Table 1. Higher amylose content caused a greater G′₁ for neat starch hydrogels, where dent starch (27% amylose), 55% amylose starch, and 72% amylose starch hydrogels showed a G′ of 35.0 Pa, 283.7 Pa, and 318.6 Pa, respectively. It is believed that a more developed supramolecular structure and stronger hydrogel network can be obtained in higher amylose content because amylose chains tend to re-associate easier than amylopectin due to their linear molecular morphology, promoting retrogradation and forming a more organized structure.

Interestingly, with dent starch hydrogels, chitosan addition significantly improved the mechanical strength of the hydrogels. Rheological data from Table 1 shows that the G′₁ of dent-0.50% C and dent-0.75% C samples increased more than 3 folds (136.1 Pa) and 4 folds (152.0 Pa) compared to dent-0% C hydrogel (35.0 Pa) (FIG. 1b, Table 1). These data indicated that the combination of dent starch with chitosan could be an effective approach for modulating the mechanical strength of the hydrogels. Dent starch does not contain sufficient linear amylose molecules to re-associate after gelatinization and produces an organized three-dimensional structure in the continuous aqueous phase through hydrogen and hydrophobic interactions during the retrogradation step. Chitosan is structurally a linear polycationic polysaccharide made up of arbitrarily distributed β-(1-4)-linked D-glucosamine and N-acetyl-D-glucosamine. As zeta-potential data showed, chitosan molecules can interact with amylose and amylopectin molecules through electrostatic interactions at pH 5.8, which is the pH starch hydrogel was produced. Thus, it can be concluded that at the presence of chitosan, the negatively charged amylose and amylopectin chains might interact with positively charged chitosan chains to compensate for the inadequate amount of linear amylose molecules in the dent starch samples and produce a stronger network, resulting in hydrogels with significantly higher storage modulus compared to the neat dent starch hydrogel. With 55 and 72% amylose starch samples, 0.50 wt. % chitosan addition also slightly improved the G′ of the hydrogels compared to the neat starch counterparts, however, this strengthening effect was not as effective as in the dent starch hydrogels. (FIG. 1c-d, Table 1). This behavior might be attributed to the fact that 55 and 72% amylose starch hydrogels were already able to produce strong hydrogels due to the presence of sufficient linear amylose molecules in these samples. Therefore, the strengthening effect of chitosan through electrostatic interactions with starch molecules was less in these samples compared to the dent starch hydrogels. Furthermore, with increasing chitosan concentration to 0.75 wt. %, the G′ of hydrogels slightly decreased compared to the 55 and 72% amylose hydrogels charged with 0.50 wt. % chitosan, particularly with samples produced from 72% amylose starch (FIG. 1c-d, Table 1). This weakening effect might be attributed to the fact that a higher concentration of chitosan molecules might interrupt the re-association of amylose chains and the formation of a strong three-dimensional network.

### 2.3. Aerogels Shrinkage and Density

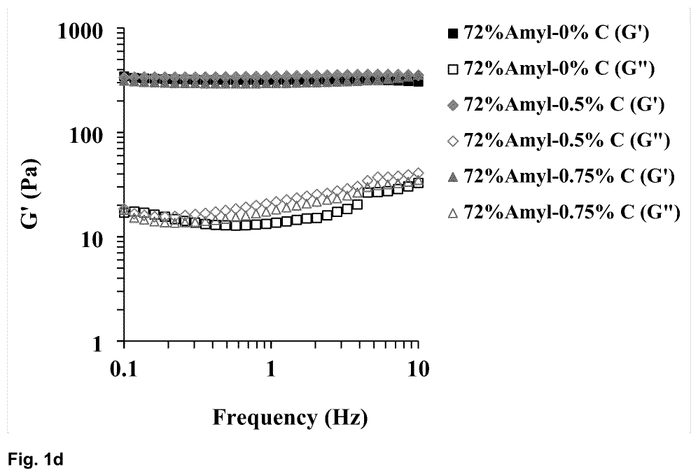

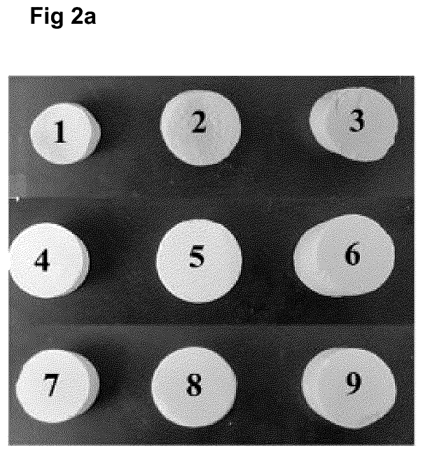

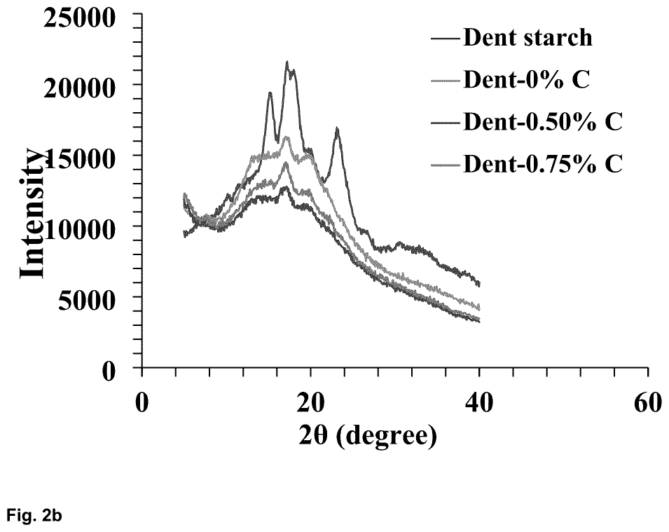

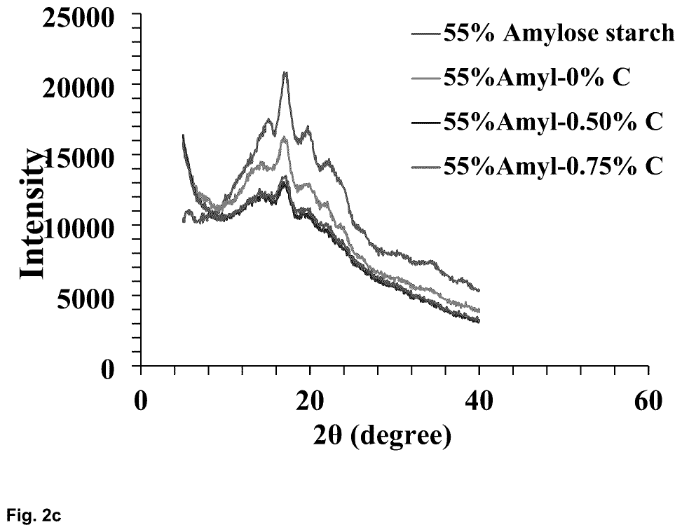

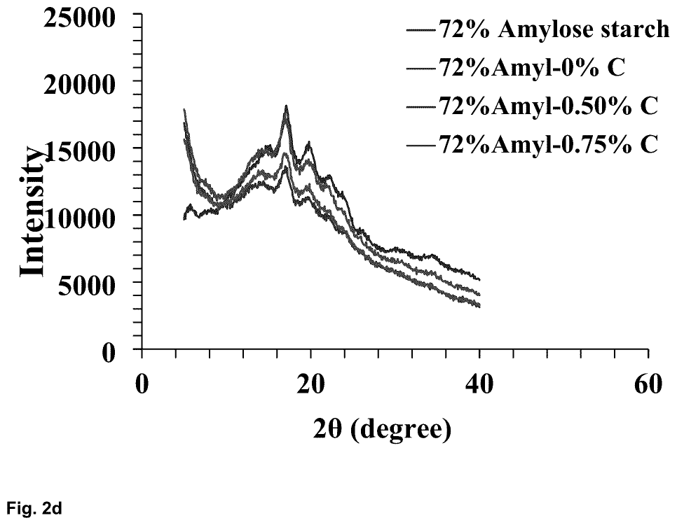

The appearance of the starch hydrogels and alcogels containing chitosan tended to be slightly yellow (images not shown), likely due to the presence of impurities in chitosan powder as the chitosan solution alone had a slightly yellowish color. The yellowish color significantly decreases after the solvent exchange/SC-CO₂ drying because of the pigment removal, and all aerogels revealed a white color regardless of the chitosan content (FIG. 2a).

The shrinkage values of the samples are shown in Table 1. All aerogel samples tended to shrinkage after water-to-ethanol solvent exchange and SC-CO₂ drying. The neat dent starch aerogel revealed the most cumulative (solvent exchange+SC-CO₂ drying) shrinkage in which this sample underwent 63.4% volume reduction compared to its parental hydrogel (FIG. 2a). Shrinkage is a common phenomenon during SC-CO₂-assisted preparation of bio-based aerogels. The exchange of the solvent from water to ethanol during the solvent exchange reduces the affinity of amylose and amylopectin chains for the surrounding solvent, resulting in increased polymer/polymer interactions. Additionally, while the solvent is evaporated from the alcogel network during SC-CO₂ drying step, the radius of curvature of the vapor-liquid interface is reduced. It exerts capillary stress on the gel network and causes shrinkage. The previous studies suggested that the shrinkage intensity of biopolymer-based aerogels is mostly controlled by the hydrogel precursors' mechanical strength. As one can see from the rheological data, the gel network of the neat dent starch sample was too weak to tolerate the stresses upon the solvent exchange and SC-CO₂ drying, so it could justify the significant shrinkage of the neat dent starch sample (dent-0% C). As the amylose matter of starch risen to 55 and 72%, shrinkage of the samples after solvent exchange/SC-CO₂ drying significantly decreased compared to the dent-0% C sample (Table 1). However, shrinkage of the neat 55 and 72% amylose starch hydrogels was still high (commutative shrinkage of 47.6 and 43.7% for 55% Amyl-0% C and 72% Amyl-0% samples, respectively). As the rheological data showed, when the amylose content of starch increased from 27% for dent starch to 55 and 72%, a stronger gel backbone was developed. It could explain the reduced amount of shrinkage of the 55% Amyl-0% C and 72% Amyl-0% hydrogels compared to the dent-0% C sample. The same effect of amylose concentration on the shrinkage was reported by us and others. Druel et al (2017) stated a volumetric shrinkage of 55, 46, and 37% for aerogels prepared from starch samples with 20, 40, and 80% amylose content (potato, pea, and high-amylose corn starch, respectively).

Interestingly, starch hydrogels supplemented with chitosan showed lower shrinkage compared to their neat starch hydrogel counterparts, particularly for samples prepared from dent starch. This observance was in accordance with the visual dimension of the aerogel samples (FIG. 2a), where the dent-0.50% C and dent-0.75% C aerogels tended to have greater volume than the dent-0% C aerogel. For dent starch samples, these results were in was in line with the rheology results of their hydrogel precursors which demonstrated that the chitosan addition significantly increased the elastic (storage) modulus of the dent starch hydrogels (FIG. 1b, Table 1). It could be speculated that hydrogel with stronger gel network were able to resist the capillary stresses and shrinkage to a greater extent during the solvent exchange and drying. However, while the strength of the hydrogels formed from 55 and 72% amylose content starch was not much different from their neat starch hydrogel counterparts, the chitosan-supplemented starch hydrogels underwent significantly less shrinkage (p<0.05). It suggested that the hydrogel mechanical strength should not be the lone parameter for the lower shrinkage of the chitosan-supplemented starch hydrogels. The greater stability of the starch hydrogels supplemented with chitosan to shrinkage could accredited to the presence of chitosan chains in the network of the starch hydrogels, where the chitosan chains increase inhomogeneity in the gel network and locate between amylose and amylopectin chains so that the network shrinkage due to the intermolecular interactions between starch chains will happen in less extent as the water is replaced with ethanol during solvent exchange step.

FIGS. 2b-d show the XRD patterns of the starch aerogel samples with different aerogel content and chitosan addition. Initial corn starch samples showed the primary diffraction peaks at 13-15°, 17°, 19-20°, and 22-23°. However, the sharp peaks on XRD patterns of the corn starch weakened after aerogel formation, indicating the starch crystallinity considerably decreased after being converted into hydrogel/aerogel. Previous authors also stated a decrease in the crystallinity of wheat starch and pea and potato starch aerogels after the aerogel formation. Interestingly, the remaining crystalline peak of 20° for dent starch aerogels and remaining crystalline peaks of 20° and 22° for 55 and 72% amylose starch samples were slightly weaker in the aerogel samples supplemented with chitosan than the neat starch aerogel equivalents. The decline in crystallinity of starch in the presence of chitosan might be a result of the interaction between the chitosan molecules and amylose and amylopectin chains. These interactions might decrease the creation of the amylose's double stranded helixes and prevent the complete recrystallization of starch chains during the retrogradation and solvent exchange/SC-CO₂ drying.

The aerogel density data is shown in Table 1. With neat starch aerogels, the 55 and 72% amylose starch aerogels tended to have significantly lower density compared to the dent starch aerogels, possibly due to the less shrinkage of former aerogels (p<0.05). Furthermore, the aerogels supplemented with chitosan had significantly less density compared to their neat starch counterparts (p<0.05), which was in accordance with the lower shrinkage of the aerogels supplemented with chitosan.

TABLE 1
The storage modulus of hydrogel precursors at the frequency of 1 Hz (G’
₁), and shrinkage and density of aerogels prepared from dent starch, 55
and 72% amylose starch mixed with 0, 0.50, and 0.75 wt. % chitosan.

| | G’₁ of | Solvent exchange | Cumulative | Density |
|---|---|---|---|---|
| Samples | hydrogel (Pa) | Shrinkage (%) | shrinkage (%) | (g/cm³) |
| Dent-0% C | 35.0 ± 5.4^{g} | 56.5 ± 1.4^{a} | 63.4 ± 1.7^{a} | 0.220 ± 0.008^{a} |
| Dent-0.50% C | 136.1 ± 6.6^{f} | 30.4 ± 3.2^{b} | 43.1 ± 2.8^{c} | 0.136 ± 0.007^{d} |
| Dent-0.75% C | 152.0 ± 5.9^{e} | 30.3 ± 5.1^{b} | 40.7 ± 2.6^{d} | 0.142 ± 0.005^{c} |
| 55% Amyl-0% C | 283.7 ± 11.2^{d} | 22.9 ± 3.2^{c} | 47.6 ± 1.9^{b} | 0.160 ± 0.004^{b} |
| 55% Amyl-0.50% C | 380.7 ± 14.1^{a} | 12.4 ± 3.6^{e} | 33.8 ± 3.8^{e} | 0.120 ± 0.003^{e} |
| 55% Amyl-0.75% C | 357.3 ± 15.4^{b} | 15.0 ± 4.3^{d} | 36.9 ± 3.8^{e} | 0.134 ± 0.009^{d} |
| 72% Amyl-0% C | 318.6 ± 17.0^{c} | 22.9 ± 2.7^{c} | 43.8 ± 2.3^{c} | 0.143 ± 0.006^{c} |
| 72% Amyl-0.50% C | 345.4 ± 12.0^{b} | 12.8 ± 2.4^{de} | 33.6 ± 2.2^{e} | 0.120 ± 0.002^{e} |
| 72% Amyl-0.75% C | 296.0 ± 18.7^{cd} | 14.7 ± 3.7^{d} | 35.4 ± 3.4^{e} | 0.133 ± 0.002^{d} |

### 2.4. Aerogel Internal Morphology, BET-Specific Surface Area, and BJH Volume

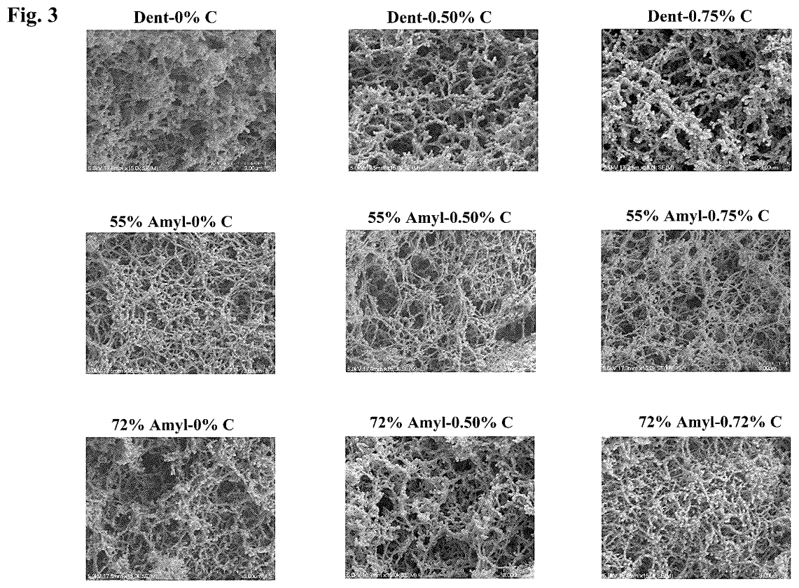

The internal morphology of the starch aerogels was studied by SEM and the images are presented in FIG. 3. Apart from the amylose and chitosan content, all starch aerogels revealed interlinked mesopores enclosed between the assembled starch fibrous constructions. This was a common architecture reported for SC-CO₂-dried starch aerogels. Between samples, dent-0% C aerogel showed a significantly more compact structure and less fibrous architecture, where this aerogel contained a “mixture” of smooth beads and a fine network. Zou and Budtova (2021) stated that starch aerogels with higher amylopectin content tended to develop a less ramified structure. The authors hypothesized that a lower amylose-to-amylopectin ratio causes weaker gel structure, and these weak gels experience a severe phase separation upon the solvent exchange/SC-CO₂ drying steps, causing an aggregated structure with less branching. With increasing amylose content, the 55% Amyl-0% C and 72% Amyl-0% C samples showed finer and more ramified structure, indicating that these samples could preserve their structure upon the solvent exchange/SC-CO₂ drying steps due to the greater mechanical strength of their hydrogel precursors. Interestingly, chitosan addition to dent starch caused the samples to produce a more fibrous and ramified structure compared to dent-0% C samples. The results might be attributed to the strengthening effect of chitosan on the mechanical properties of the dent starch hydrogels: the stronger the gel (case of dent-0.50% C and dent-0.75% C hydrogels), the better it keeps the fibrous network structure. It was in agreement with the density and shrinkage results in which the dent-0% C sample showed the highest shrinkage (63%), while chitosan addition significantly decrease the shrinkage of the dent starch samples (Table 1). The chitosan addition had a less noticeable effect on the microstructure of 55 and 72% amylose starch samples, as these samples already showed a fibrous and ramified structure even in the absence of chitosan.

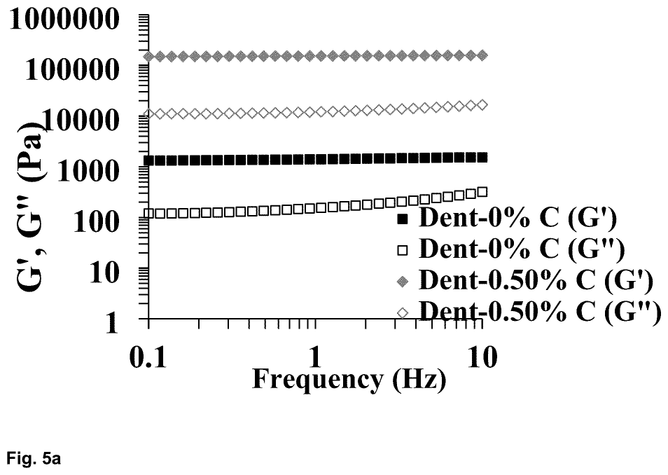

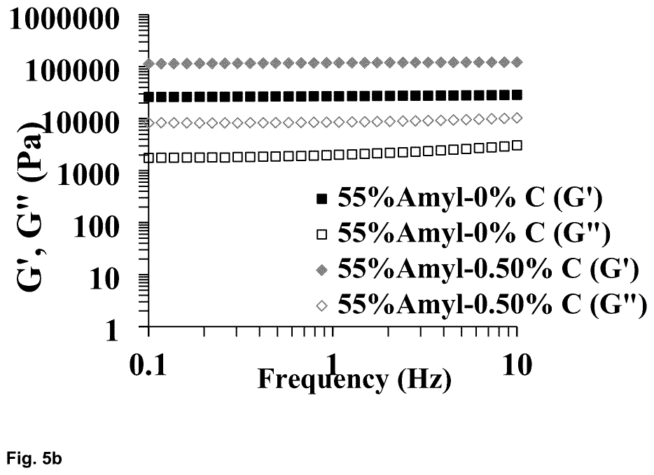

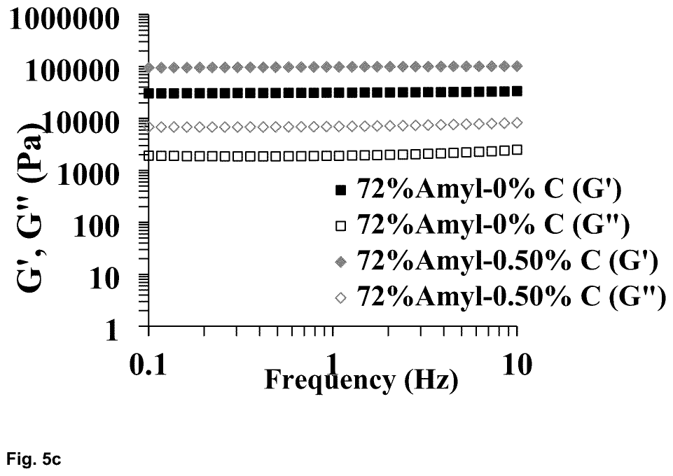

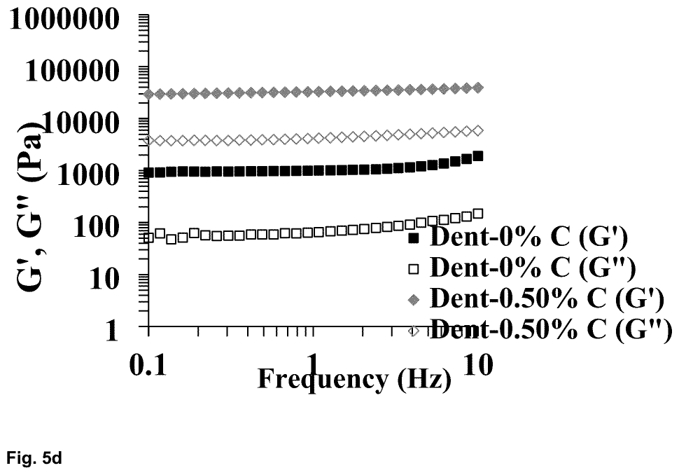

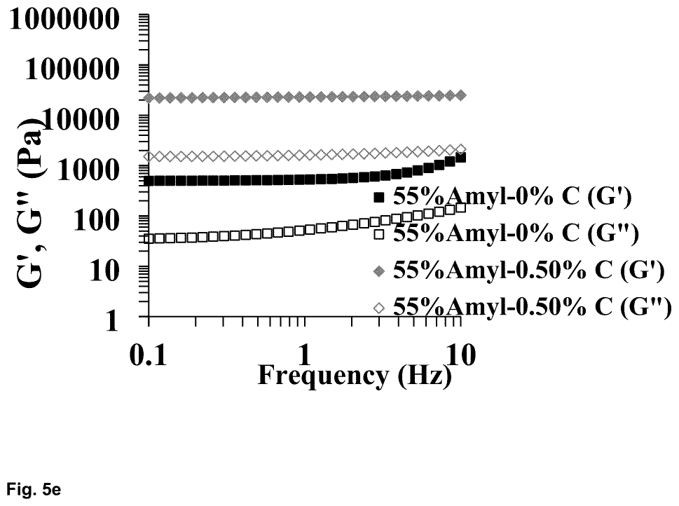

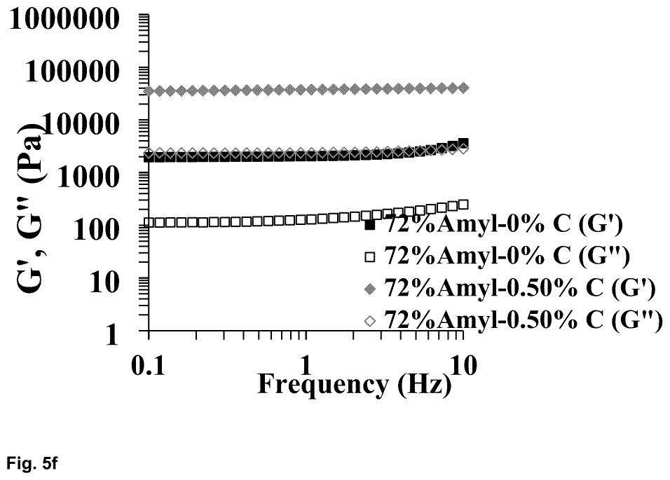

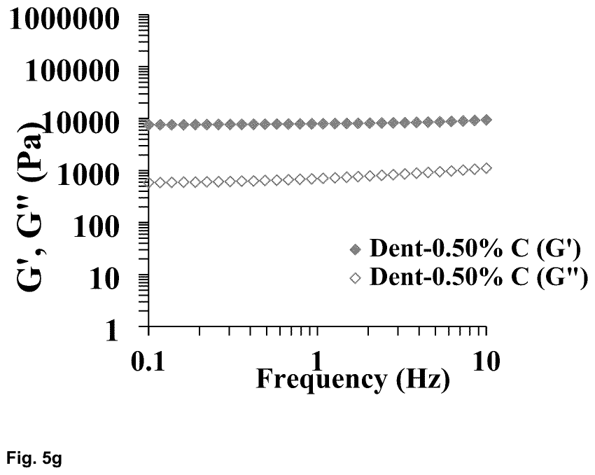

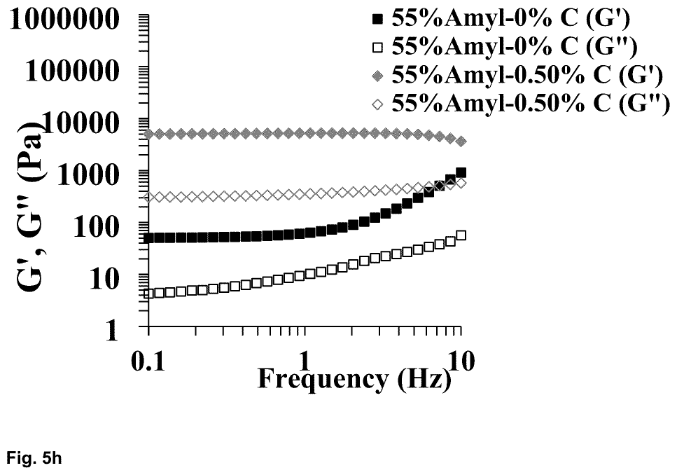

The BET surface area and BJH pore volume of the aerogel samples are presented in Table 2. With neat starch samples, starch type has a significant influence on the specific surface area of aerogels: a higher amylose content (72% Amyl>55% Amyl>dent starch) translated to a greater BET-specific surface area. The 72% Amyl-0% C shows the highest specific surface area among all aerogels studied, with a specific surface area of 199.8 m2/g vs 167.6 and 73.5 m2/g for 55% amylose starch and dent starch aerogels, respectively (FIG. 5b). Open fine and ramified internal morphology of 72 and 55% amylose starch aerogels (FIG. 3) was the reason for this higher specific surface area of these samples compared to the dent-0% C aerogel. The results were in line with those reported by Dogenski et al. (2020) (BET-specific surface area of 120-169 m2/g for 70% amylose corn starch) and Baudron, Gurikov, Smirnova, & Whitehouse (2019) (surface area of 197 m2/g for 67% amylose starch). Druel et al. (2017) reported BET-specific surface areas of 88, 85, 221, and 254 m2/g for waxy potato starch (0% amylose), regular potato starch (20% amylose), pea starch (40% amylose), and high amylose corn starch (80% amylose), respectively. As seen in Table 2, chitosan addition significantly increased the BET-specific surface area of all aerogels, regardless of the type of starch. This effect might be ascribed by the lesser shrinkage of the aerogels supplemented with chitosan, where chitosan molecules inhibited phase separation and molecular fusion of amylopectin and amylose chains upon the solvent exchange/SC-CO2 drying, keeping the branched porous network structure of the aerogels. In line with the surface area results, the BJH mesopore volume (Vmes) data showed that the aerogels with higher amylose content had the highest BJH mesopore volume, and chitosan addition resulted in a greater BJH mesopore volume.

According to International Union of Pure and Applied Chemistry (IUPAC), the pore size of porous materials is categorized into three classes: the pores with diameters less than 2 nm called micropores, the pores with diameters 2-50 nm called mesopores, and the pores with diameters bigger than 50 nm called macropores. BET analysis restricted to analysis of the pores in the mesopores region (2-50 nm) and this technique is not able to assess the pore size and pore volume of materials out of this size range (e.g., macropores). The t-plot of nitrogen absorption/desorption data suggested that there was no significant quantity of micropores (pores less than 2 nm) in these starch aerogels. Thus, an approximation of the total volume of macropores (Vmacro) of the aerogels can be determined using the equation (5) and the results reported in Table 2:

$${V}_{m a c r o} = \frac{1}{dens i t y} - {V}_{m e s o} \qquad ( 5 )$$

The dent-0% C aerogel showed the least macropore volume among the studies samples, while the chitosan addition increased macropore volumes of the dent-0.50% C and dent-0.75% C aerogels by 63% and 56% (Table 2). These results were in agreement with SEM pictures (FIG. 3) in which a macroporous network (micron-sized pores greater than 100 nm) exists in dent-0.50% C and dent-0.75% C aerogels, while dent-0% C aerogel tended to have a denser and packed network because of the higher shrinkage this sample underwent during solvent exchange/S-CO₂ drying. Furthermore, chitosan addition increased the macropore volume of 55 and 72% amylose aerogels, but this effect of chitosan on the high amylose starch aerogels was less compared with dent starch aerogels.

TABLE 2
BET surface area, BJH mesopore volume, average mesopore size, and macropore
volume of aerogels prepared from dent starch, 55% amylose starch, and
72% amylose starch mixed with 0, 0.50, and 0.75 wt. % chitosan.

| | BET surface | BJH mesopore | Average mesopore | Macropore |
|---|---|---|---|---|
| Samples | area (m²/g) | volume (cm³/g) | size (nm) | volume (cm³/g) |
| Dent-0% C | 73.5 ± 2.9ⁱ | 0.101 ± 0.003ⁱ | 11.3 ± 0.1^{c} | 4.44 ± 0.23^{g} |
| Dent-0.50% C | 79.3 ± 3.1^{h} | 0.108 ± 0.002^{h} | 10.1 ± 0.1^{e} | 7.23 ± 0.14^{c} |
| Dent-0.75% C | 86.8 ± 3.7^{g} | 0.113 ± 0.001^{g} | 11.0 ± 0.2^{d} | 6.95 ± 0.09^{d} |
| 55% Amyl-0% C | 167.6 ± 3.4^{f} | 0.230 ± 0.002^{f} | 11.4 ± 0.2^{c} | 6.01 ± 0.11^{f} |
| 55% Amyl-0.50% C | 203.6 ± 4.1^{c} | 0.318 ± 0.003^{c} | 12.2 ± 0.1^{b} | 8.00 ± 0.08^{a} |
| 55% Amyl-0.75% C | 176.9 ± 2.8^{e} | 0.281 ± 0.003^{e} | 12.1 ± 0.1^{b} | 7.18 ± 0.12^{c} |
| 72% Amyl-0% C | 199.8 ± 3.2^{d} | 0.295 ± 0.004^{d} | 12.2 ± 0.2^{b} | 6.71 ± 0.07^{e} |
| 72% Amyl-0.50% C | 219.7 ± 3.0^{a} | 0.346 ± 0.003^{a} | 12.0 ± 0.1^{b} | 7.99 ± 0.05^{b} |
| 72% Amyl-0.75% C | 213.2 ± 2.5^{b} | 0.336 ± 0.002^{b} | 13.6 ± 0.1^{a} | 7.19 ± 0.11^{c} |

### 2.5. Properties of the Oleogels

The oleogelation capacity of the aerogel samples was investigated by blending and homogenizing the aerogel powders and soybean oil with several aerogel-to-oil ratios (w/w). For oleogelation experiments, neat starch aerogels and only starch aerogels supplemented with 0.50 wt. % chitosan were studied, as the previous aerogel characterization data and our preliminary experiments on oleogelation properties showed that the aerogels supplemented with 0.50 wt. % chitosan offered reduced shrinkage and density, greater microporosity, and better oleogelation capacity than those aerogels supplemented with 0.75 wt. % chitosan.

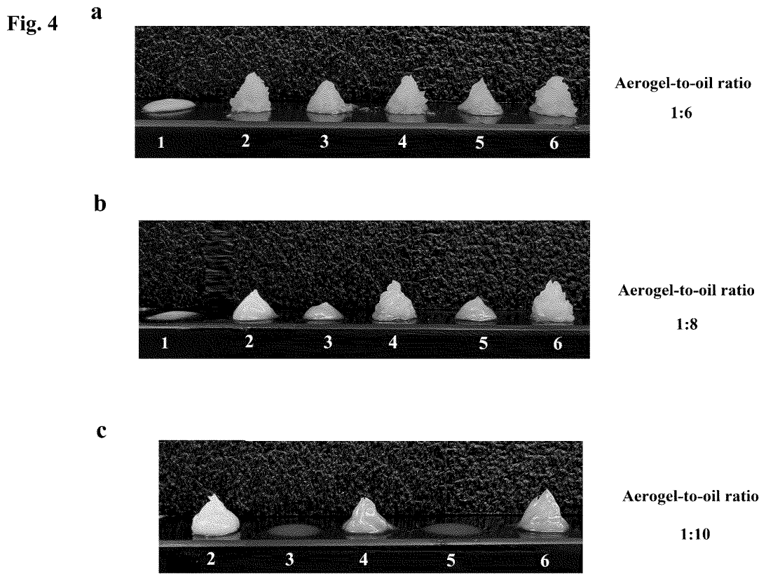

FIG. 4 indicates the visual images of the oleogels created by starch aerogel samples. The neat dent starch aerogel (dent-0% C) was not able to create a self-supporting oleogel at all studied aerogel-to-oil ratios even at the highest aerogel ratio (aerogel-to-oil ratio of 1:6, FIG. 4a, sample 1). With the aerogels made from 55 and 72% amylose starch, a self-supporting oleogel was only created at the maximum studied aerogel content (1:6 aerogel-to-oil ratio, FIG. 4a, samples 3 and 5), while at the aerogel-to-oil ratio of 1:8, the visual consistency of aerogel significantly decreased. At the lowest aerogel concentration (aerogel-to-oil ratio of 1:10), there was no visual oleogelation capacity for the aerogels made from neat 55 and 72% amylose starch and the samples had an oily consistency (FIG. 4c, samples 3 and 5).

Importantly, the dent starch aerogels supplemented with chitosan showed a strong plastic oleogel texture at the aerogel-to-oil ratio of 1:6, and these samples kept their oil structuring capacity even at the lower aerogel content, where a weaker but still plastic texture was established at the aerogel-to-oil ratio of 1:8 and 1:10, while neat dent starch aerogel could not to create an oleogel structure even at the aerogel-to-oil ratio of 1:6. The same effect was also observed for the aerogels samples prepared from 55 and 72% amylose starch, where the chitosan addition significantly increased the oleogelation capacity of these samples; strong plastic texture were created at the aerogel-to-oil ratio of 1:8 and 1:10 for aerogels made from 55 and 72% amylose starch and supplemented with 0.50 wt. % chitosan (FIGS. 4b and c, samples 4 and 6). This primary visual evaluation suggested the better oil structuring capacity of the aerogels obtained from starch samples with higher amylose content and the aerogel samples supplemented with chitosan compared to those prepared from dent starch and those without chitosan addition. To quantitative measurement of rheological characteristic of the oleogel samples, rheological experiments were performed.

### 2.5.1. Rheological Properties of the Oleogels

The frequency sweep analysis was done to provide rheological information on the solid-like properties of the oleogels and the results are presented in FIG. 5. In the oleogel made by dent-0% C aerogels, the storage modulus (G′) was extremely low when the oleogels were made from aerogel-to-oil ratios of 1:8 and 1:10; therefore, the results of these samples were not reported. For all samples, G′ was constantly greater than G″ at the frequency of 0.1-10 Hz, indicating the presence of a gel-network structure. Furthermore, it is obvious from the viscoelastic curves that the viscoelastic moduli of oleogels prepared from starch aerogels supplemented with chitosan were significantly higher than the ones prepared from neat starch aerogels, irrespective of the starch type and the aerogel-to-oil ratio. This result was in accordance with the visual images of the aerogels in which the oleogels prepared from starch aerogels supplemented with chitosan showed stronger consistency and self-supporting texture (FIG. 4).

To study the stiffness of the oleogels, the Power-law equation (G′=a ωⁿ) was applied to fit the frequency (ω) dependence of G′ of the oleogels and the obtained variables are presented in Table 3. The “a” parameter shows the G′ value at the frequency of 1 Hz and relates to the elastic stiffness of the oleogels; “n” shows the slope of the G′ curve and an “n” value of near zero suggests the presence of a mainly elastic system. In the absence of chitosan, the aerogels prepared from starch with 55 and 72% amylose produced oleogels with a significantly higher elastic strength compared to dent starch aerogel. Furthermore, decreasing the ratio of the aerogel to oil from 1:6 to 1:8 and 1:10, the “a” values of the samples decreased significantly (Table 3); with the aerogel-to-oil ratio of 1:8 and 1:10, the “a” values of these oleogels were fairly low. Plazzotta et al. (2021) showed that oil is physically entrapped in macropores spaces of the aerogels of whey protein, while mesopores showed only a limited impact on oleogelation capacity of the aerogels. It might be due to this fact the main volume of aerogels occupies by macropores, as data from Table 2 showed that the macroporous volume of aerogels was several ten times the volume occupied by mesopores. Plazzotta et al. (2021) also reported that the oleogelation capacity of aerogels is controlled by the interactions between aerogel particles spread in the oil phase. The aerogel particles with less density and greater macroporosity could occupy higher volume of the oleogel network in a constant aerogel weight. When greater amount of oil is absorbed into the internal structure of the aerogel particles, the aerogel particles with lower density could produce a packed three-dimensional network because of their higher population per volume of the oleogel. Thus, the higher oleogelation capacity of the 55 and 72% amylose starch aerogels compared to dent starch aerogels could be ascribed by the greater macroporous volume of the former aerogels than the former ones, as the macroporosity results confirmed that the neat starch aerogels prepared from 55 and 72% amylose starch had 35 and 51% more macroporous volume compared to the neat dent starch aerogel (Table 2).

Remarkably, in line with the visual pictures of the oleogels (FIG. 4), the starch aerogels supplemented with chitosan produced oleogels with significantly higher elastic strength than those made from neat starch aerogels in all studied aerogel-to-oil ratios. In the aerogel-to-oil ratio of 1:6, dent starch aerogel supplemented with 0.50 wt. % chitosan (dent-0.50% C) showed the highest “a” value; while the oleogel prepared from neat dent starch aerogel had runny consistency with “a” value as low as 0.14×10⁴ Pa, the oleogel prepared from dent-0.50% C produce a solid plastic oleogel with “a” value as high as 15.32× 10⁴ Pa. As macroporosity data revealed (Table 2), chitosan addition to dent starch resulted in aerogels with 63% more macroporous volume than the neat dent starch aerogel. As mentioned before, higher macroporosity is associated with higher oil absorption capacity and greater oil structuring ability. Furthermore, chitosan addition resulted in a increase in the oleogelation capacity of the aerogels prepared from 55 and 72% amylose starch, whereas oleogels made from 55% Amyl-0.50% C and 72% Amyl-0.50% C aerogels showed more than 4- and 3-times elastic strength (“a” value) compared to the oleogels prepared from neat starch aerogel counterparts at the aerogel-to-oil ratio of 1:6. With decreasing aerogel content of the oleogels (aerogel-to-oil ratio of 1:8 and 1:10), the elastic strength of the oleogels decrease significantly compared with the aerogel-to-oil ratio of 1:6 (p<0.05), but the oleogels prepared from aerogels supplemented with chitosan still showed strong and self-supporting structure even at the aerogel-to-oil ratio of 1:10 (Table 2, FIG. 4). Chitosan addition increased macropores volume of the 55 and 72% amylose starch aerogels by 33 and 19%, respectively, compared to their neat starch aerogel counterparts (Table 2). This observation might explain the higher oil structuring capacity of the aerogel supplemented with chitosan. It is worth noting that the change in surface chemistry and molecular characteristics of the aerogels as a result of chitosan addition should be also considered in further studies, as it might contribute to the oleogelation performance of the aerogels.

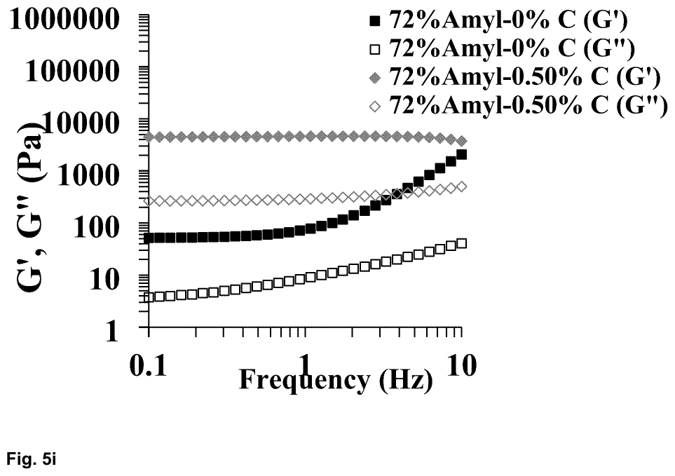

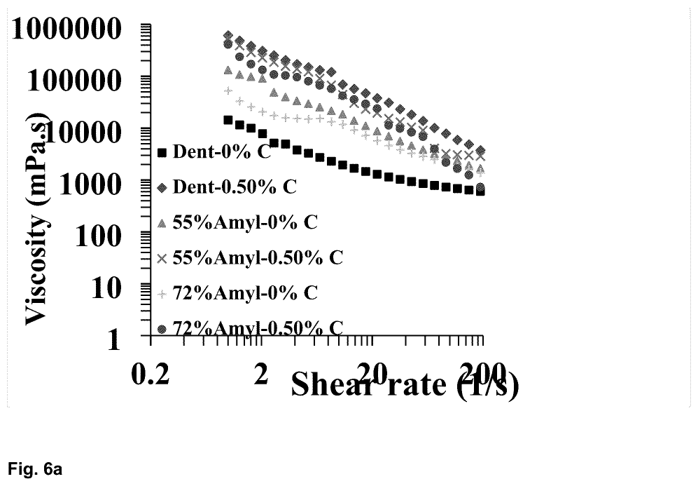

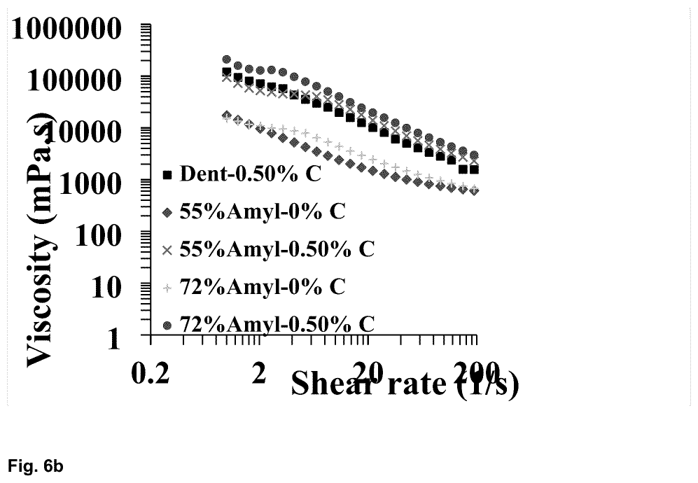

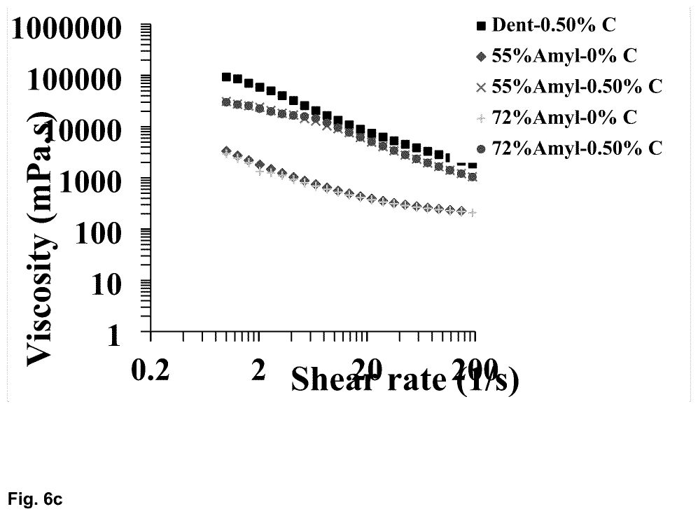

FIG. 6 indicates the flow behaviour of the oleogels produced by various aerogels and aerogel-to-oil ratios (the dent-0% C aerogels with 1:8 and 1:10 aerogel-to-oil ratios were not reported because gel structures were not formed). The flow curves confirmed that all oleogel samples had a strong shear-thinning performance at the shear rate range of 1-200 l/s. This shear-thinning behaviour suggested a remarkable shear-induced structural collapse in the oleogel samples. To obtain additional information about the flow performance of the oleogels, the Power-law model (τ=K·(γ)ⁿ) were used to fit the viscosity-shear rate curves of the oleogels and the fitted variables are presented in Table 3. In compliance with the visual pictures of aerogels (FIG. 4) and frequency sweep data, the oleogels made with neat dent starch aerogel (dent-0% C) at the aerogel-to oil ratio of 1:6 showed extremely low consistency indexes (k˜ 1.0 Pa·sⁿ), suggesting these samples did not possess a sufficient structure. Additionally, the oleogels made from neat starch with 55 and 72% amylose aerogel showed a significantly higher consistency index than those produced from neat dent starch aerogel. Remarkably, the oleogels made by the aerogel supplemented with chitosan showed a considerably higher consistency index than their neat starch aerogel counterparts. When decreasing the aerogel content of oleogels, the consistency index of all oleogel samples decreased, which was in accordance with the remarkable decline in the visual structure of the oleogels with lower aerogel ratio (FIG. 4). However, those oleogels prepared from aerogels supplemented with chitosan still had a great consistency index at the aerogel-to-oil ratios of 1:8 and 1:10. This higher consistency index of the oleogels prepared from aerogels supplemented with chitosan could be ascribed by the greater macroporous volume of the aerogels than the neat starch aerogels, as discussed before.

In Table 3, the “n” value shows the shear rate dependence of viscosity, where a “n” value near zero means a strong shear-thinning behavior. While all oleogels revealed a shear-thinning behavior (“n” value less than 1.0), the oleogels with a greater consistency index tended to have higher shear-thinning performance (lower “n” value). As discussed above, during oleogelation, with absorption of oil from the continuous phase of the oleogel into the macroporous space of aerogel particles, the aerogel particles become close to each other so that the particle-particle interactions create a remarkable resistance to shear deformation, translating to the high consistency of these samples. However, due to the non-covalent nature of these interactions (e.g., hydrophobic interaction and hydrogen bonds), most of the interactions are broken upon the high shear rate, and the oil-loaded particles line up in the direction of flow, causing a strong shear-thinning performance in the oleogel samples. The high consistency index at the rest and strong shear-thinning behavior upon the shear in these oleogels can be valuable for their food applications for instance, in pumping, squeezing, and extruding.

TABLE 3
Elastic stiffness (a), frequency dependency (n), consistency index (k),
and flow behavior index (n) of oleogels made by aerogels prepared from
dent starch, 55% amylose starch, and 72% amylose starch mixed with 0 and
0.50 wt. % chitosan at aerogel-to-oil ratios of 1:6, 1:8, and 1:10.

| | Frequency sweep | | | Flow behavior | | |
|---|---|---|---|---|---|---|
| Samples | a (Pa) | n | R² | k (Pa · sⁿ) | n | R² |
| Dent-0% C (1:6) | 0.14 × 10^{4 k} | 0.04^{d} | 0.99 | 1.03 × 10^{4 m} | 0.39^{c} | 0.97 |
| Dent-0.50% C (1:6) | 15.32 × 10^{4 a} | 0.01^{f} | 0.99 | 68.82 × 10^{4 a} | 0.03ⁱ | 0.99 |
| 55% Amyl-0% C (1:6) | 2.72 × 10^{4 f} | 0.02^{ef} | 0.99 | 12.85 × 10^{4 f} | 0.15^{h} | 0.98 |
| 55% Amyl-0.50% C (1:6) | 11.84 × 10^{4 b} | 0.02^{e} | 0.99 | 54.41 × 10^{4 b} | 0.01^{j} | 0.99 |
| 72% Amyl-0% C (1:6) | 3.16 × 10^{4 e} | 0.02^{ef} | 0.97 | 4.14 × 10^{4 j} | 0.36^{c} | 0.94 |
| 72% Amyl-0.50% C (1:6) | 9.85 × 10^{4 c} | 0.02^{e} | 0.99 | 42.63 × 10^{4 c} | 0.01^{j} | 0.97 |
| Dent-0% C (1:8) | — | — | — | — | — | — |
| Dent-0.50% C (1:8) | 3.33 × 10^{4 e} | 0.06^{c} | 0.99 | 13.82 × 10^{4 e} | 0.14^{h} | 0.99 |
| 55% Amyl-0% C (1:8) | 0.05 × 10^{4 l} | 0.04^{d} | 0.91 | 1.39 × 10^{4 l} | 0.34^{de} | 0.99 |
| 55% Amyl-0.50% C (1:8) | 2.32 × 10^{4 g} | 0.02^{ef} | 0.98 | 11.16 × 10^{4 h} | 0.29^{f} | 0.96 |
| 72% Amyl-0% C (1:8) | 0.2 × 10^{4 j} | 0.03^{e} | 0.92 | 1.84 × 10^{4 k} | 0.36^{d} | 0.98 |
| 72% Amyl-0.50% C (1:8) | 3.76 × 10^{4 d} | 0.03^{e} | 0.99 | 26.26 × 10^{4 d} | 0.16^{h} | 0.97 |
| Dent-0% C (1:10) | — | — | — | — | — | — |
| Dent-0.50% C (1:10) | 0.82 × 10^{4 h} | 0.04^{d} | 0.92 | 9.57 × 10^{4 i} | 0.22^{g} | 0.99 |
| 55% Amyl-0% C (1:10) | 0.01 × 10^{4 m} | 0.07^{b} | 0.9 | 0.24 × 10^{4 n} | 0.46^{b} | 0.98 |
| 55% Amyl-0.50% C (1:10) | 0.5 × 10^{4 i} | 0.02^{e} | 0.97 | 3.95 × 10^{4 j} | 0.32^{e} | 0.98 |
| 72% Amyl-0% C (1:10) | 0.01 × 10^{4 m} | 0.09^{a} | 0.9 | 0.2 × 10^{4 n} | 0.51^{a} | 0.95 |
| 72% Amyl-0.50% C (1:0) | 0.5 × 10^{4 i} | 0.01^{f} | 0.98 | 3.96 × 10^{4 j} | 0.32^{e} | 0.97 |

### 2.5.2. Thermal Behaviour of Oleogels

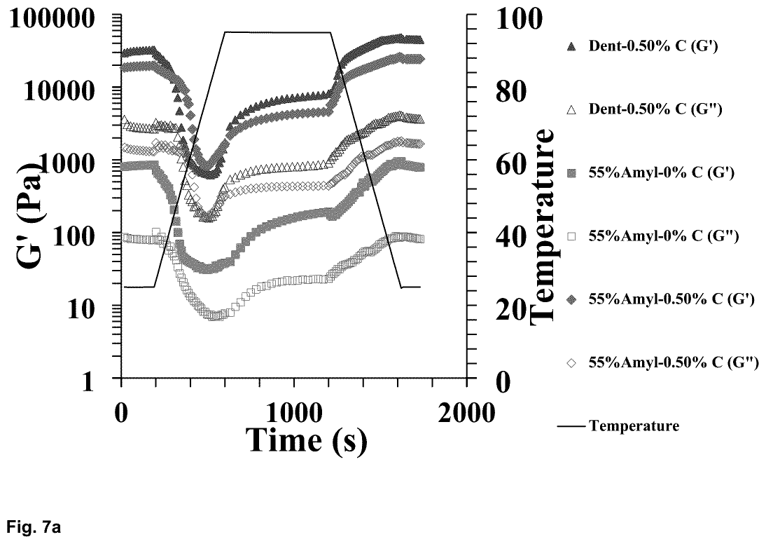

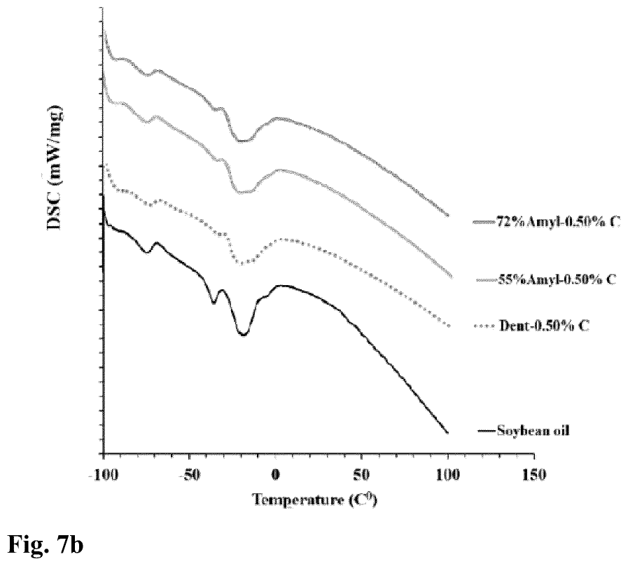

In addition to the gel strength, the behavior of oleogels under different processing conditions, such as thermal processing, is important for food applications. To study the effect of heat treatment on the resulting oleogel, a temperature sweep test was done on dent-0.50% C, 55% Amyl-0.50% C, and 55% Amyl-0% C oleogels produced from the aerogel-to-oil ratio of 1:8. Here, the temperature was increased to 95° C. and after a holding time of 10 min, the temperature was decreased again to 25° C., and the heating and cooling curves are shown in FIG. 7a. G′ first reduced as a function of increasing temperature, implying that the molecular movements within the oleogel network increase with increasing temperature (FIG. 7a). The G′ increased to some extent during the holding phase at 95° C., and during cooling to 25° C., G′ had increased but there is a no substantial difference between the initial G′ of oleogels and the G′ of the oleogels after the heating/cooling cycle, indicating that upon heating no significant change in the microstructure of the oleogels was developed. Throughout the heating and cooling cycle, the G′ always dominated G″, indicating the system remained as gel during heating. Furthermore, our visual assessment showed no evidence of oil separation in any of the oleogels after the heating/cooling cycle (FIG. 7a shows dent-0.50% C oleogel after the heating/cooling cycle on the rheometer plate).

To assess if the oleogelation has any effect on the melting profile of soybean oil, melting behavior of the dent-0.50% C, 55% Amyl-0.50% C, and 72% Amyl-0.50% C oleogels produced from the aerogel-to-oil ratio of 1:6 was studied and compared with soybean oil. FIG. 7b shows DSC melting curves of the oleogels and soybean oil. Soybean oil had three distinct exothermic peaks at −74.2, −35.5, and −18.5° C., which corresponded to three major TAG groups of soybean oil (triunsaturated (UUU), desaturated (SUU), and monounsaturated (SSU), respectively). The oleogelation did not affect the melting profile of soybean oil, and all studied oleogel samples showed the same three distinct exothermic peaks. It indicates that the entrapment of oil in the aerogel particles was mainly physical in nature.

### 3. CONCLUSIONS

Macroporosity and density of starch aerogels can be changed by changing by amylose content of the starch and chitosan addition. While the dent starch (27% amylose content) produced aerogels with higher density and low macroporosity, starch samples with higher amylose content produced aerogels with higher macroporosity and lower density because the latter samples were able to produce stronger hydrogel precursors tending to have less shrinkage upon the solvent exchange/SC-CO₂ drying steps. Furthermore, the results showed that chitosan addition produced hydrogel precursors with stronger mechanical properties, resulting in less shrinkage upon the solvent exchange/SC-CO₂ drying steps and fabrication of aerogels with less density and greater macroporous volume compared to the neat starch aerogel counterparts. The lighter composite chitosan/starch aerogels tended to have greater oil structuring capacity for the fabrication of solid plastic oleogels. This greater oleogelation ability was ascribed to the less density of the aerogels supplemented with chitosan, where the aerogels had more space to absorb oil in the oleogel network than the aerogels from the neat starch aerogels. These results propose a new idea for using chitosan to fabricate composite aerogels with greater capacity to create bio-functional food formulations.

What is claimed is:

1. A starch bioaerogel composition comprising:
a. a quantity of starch; and
b. a quantity of solubilized chitosan.

2. The starch bioaerogel composition of claim 1, wherein the quantity of chitosan ranges from 0.1% to 1% by weight.

3. The starch bioaerogel composition of claim 1, wherein the quantity of chitosan is between 0.25% to 0.75% by weight.

4. The starch bioaerogel of claim 1, wherein the starch contains a quantity of amylose.

5. The starch bioaerogel of claim 4, wherein the quantity of amylose ranges from 27-80%.

6. The starch bioaerogel of claim 5, wherein the quantity of amylose is selected from the group consisting of 27%, 55%, and 72%.

7. The starch bioaerogel of claim 1, wherein the quantity of starch is between 0.1% and 20%.

8. The starch bioaerogel of claim 1, wherein the bioaerogel was formed by evaporating alcohol from an alcogel.

9. A method of making a starch bioaerogel comprising the step of adding a quantity of chitosan to a quantity of starch during the formation of an aerogel.

10. The method of claim 9, wherein the chitosan is solubilized.

11. The method of claim 9, wherein the quantity of chitosan ranges from 0.1% to 1% by weight.

12. The method of claim 9, wherein the quantity of chitosan is between 0.25% to 0.75% by weight.

13. The method of claim 9, wherein the starch contains a quantity of amylose.

14. The method of claim 13, wherein the quantity of amylose ranges from 27-80%.

15. The method of claim 13, wherein the quantity of amylose is selected from the group consisting of 27%, 55%, and 72%.

16. The method of claim 9, wherein the quantity of starch is between 0.1% and 20%.

17. The method of claim 9, further comprising the steps of:
a. solubilizing the quantity of chitosan in an aqueous solution to form a chitosan solution;
b. mixing the chitosan solution with the quantity of starch to form a hydrogel;
c. gelatinizing the starch in the hydrogel;
d. allowing the starch in the hydrogel to retrograde;
e. transforming the hydrogel to an alcogel by performing a solvent exchange using alcohol; and
f. evaporating the alcohol to form the bioaerogel.

18. The method of claim 17, wherein the hydrogel comprises 10% starch (w/w).

19. An oleogel comprising the bioaerogel of claim 1 and oil.

20. A food product incorporating the bioaerogel of claim 1.

21. A method of improving at least one characteristic of a bioaerogel comprising the step of making the bioaerogel of claim 1, wherein the improvement of the at least one characteristic is in comparison to a bioaerogel that does not comprise the bioaerogel of claim 1.

22. The method of claim 21, wherein the at least one characteristic is selected from the group consisting of less shrinkage, less density, greater microporosity, greater oil structuring capacity, and any combination thereof.
